(19) United States
(12) Patent Application Publication
(10) Pub. No.: US 2008/0174566 A1
(43) Pub. Date: Jul. 24, 2008

(54) System For the Perception of Images Through Touch

(76) Inventors: Maria Fernanda Zuniga Zabala, Risaralda (CO); John Alexis Guerra Gomez, Risaralda (CO); Felipe Restrepo Calle, Risaralda (CO); Jose Alfredo Jaramillo Villegas, Risaralda (CO)

Correspondence Address: ROBERTO J. RIOS, 256 ELEANOR ROOSVELT, SAN JUAN, PR, 00918, US

(21) Appl. No.: 11/911,964

(22) PCT Filed: Apr. 21, 2006
(86) PCT No.: PCT/IB06/01502

§ 371 Date: Oct. 19, 2007

(30) Foreign Application Priority Data
Apr. 21, 2005 (CO) 05-37765
Apr. 11, 2006 (CO) 06-034977

(51) Int. Cl. G06F 3/041

(52) U.S. Cl. 345/173; 345/179

(57) ABSTRACT

The invention relates to a system for the perception of images through touch. The inventive comprises hardware and software which enable any person with the sense of touch to perceive images, said system being intended for visually-impaired persons. The hardware comprises a peripheral which uses electromagnetic fields in order to represent forms, figures, colours or any image that can be displayed on a computer screen an hand device which enables the user to perceive signals. The software comprises a system with selects, process, encodes and transmits the images to be represented at the peripheral, enabling the user to select the area of the image to be represented, using a set of operations (including scrolling, approaching, changing definition). The system can also be used to establish a position of the plane of the image using a position sensor with constant updating.

### PRIOR ART

There are peripherals in the trade for the interaction of the visually impaired users with equipment such as Braille Displays from Keyalt with 40 to 80 Braille cells. These devices include voice recognition software or verbal description of the elements on the screen.

The devices on the trade are restricted to text handling; such is the case of Braille Displays n which the text show non the computer is dynamically represented through microelectronics in Braille text. There are other devices that print any text that can be shown on the screen in Braille.

Speech Software, on the other hand describes and reads what is on the screen, it is restricted by the oral description of shapes, which the computer can not do very accurately.

Additionally Braille keyboards have the limitation of requiring the understanding of Braille language in order to be able to use them.

### ADVANTAGES

The most important advantage is the possibility to dynamically represent any kind of image, allowing the distinction of shapes and colors. The invention involves external sensors that can be coded in any language.

Another great advantage is the design that allows the identification of a position in the processed image, and also the path followed along the image, zooming in or zooming out.

Any kind of image can be represented with a possibility to represent Braille coded text, everything on the screen can be shown at any moment, any picture, or a sequence of images that becomes a video; with a webcam everything in the surroundings can be represented in real time. The objective is to represent any object on the screen the way a sighted person would see it.

### DETAILED DESCRIPTION OF THE INVENTION

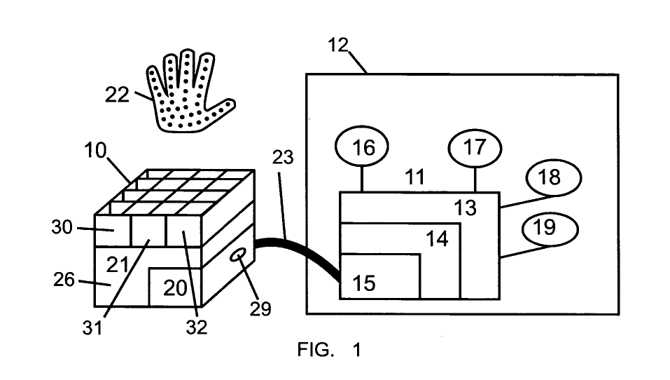

FIG. 1 shows the block diagram of the system with a glove (22) as an output device.

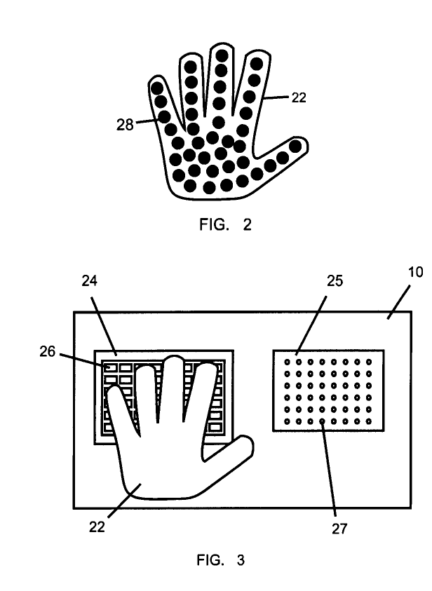

FIG. 2 shows the glove (22) for the use of a visually impaired person.

FIG. 3 shows the application of the glove (22) in the peripheral (10) that contains the electromagnet grid (24) and the led grid (25).

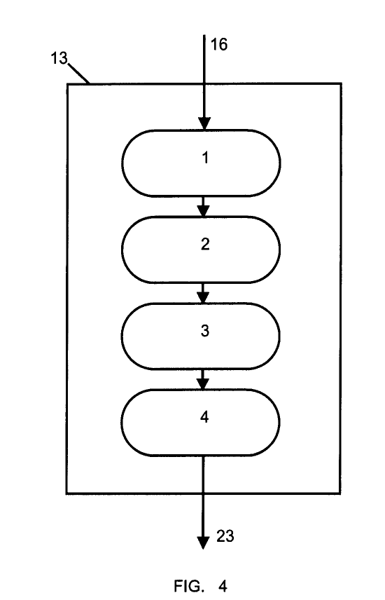

FIG. 4 shows the image processing procedure.

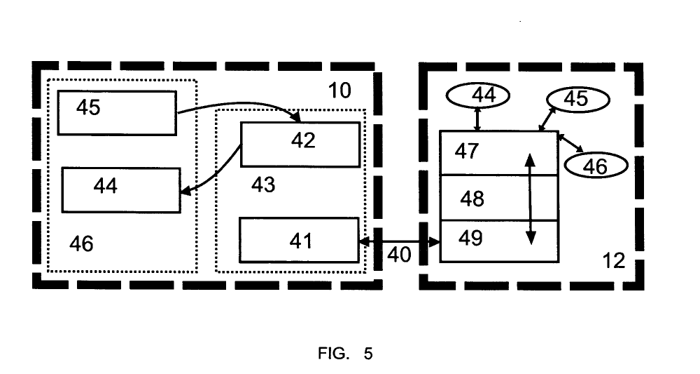

FIG. 5 shows the hardware modules (10) in the peripheral and the software models (12) in the computer.

The system basically consists of a hardware part in the peripheral (10) and a software part (12) in the computer.

System configuration in its independent components can be done with Programmable Logical Devices (PLD), USB connection Electronic components, Printed Circuits, Power electronic devices, digital electronics devices, general electronic devices, coupling electronic devices, ferromagnetic materials (magnets, electromagnet cores, among others), function extension accessories, such as PDAs, webcams, cameras, scanners for module adapting, cables, wires, stationery for diffusion and other conducting elements.

An example of the system configuration and application can be seen in FIG. 1 with a frequency emitting glove according to a shape of color.

In FIG. 1 the different software layers can be seen, each one of them with a particular function.

In the computer (12) processing and communication responsibilities are divided in layers, the layers below have a lower level than the ones above. The layers, in ascending order are: software modules (11), daemon (13), LibUSB (14) and USB core (15). The software was developed for the GNU/Linux platform, but it's portable for other free versions of other UNIX operating systems such as FreeBSD, OpenBSD and NetBSD.

With no intention of requesting patentability protection we just want to explain this aspect related to the software. Software modules are applications in charge of handing images to be processed to the Daemon layer (13), these images come from different information sources, such as: any image (16), the full contents of the computer screen (17), an image of one or several Braille coded characters (18), a sequence of images captured in a video stream file (19).

As an application it's presented according to FIG. 4, a prototype in which only the image module (16) was implemented, because this module is the base for all the others. This module consists in loading an image file in any format and hand it to the daemon layer (13).

For implementation of this module Python language was used, Python image library (PIL) and the graphic library wxPython.

The daemon layer (13) is a program in constant execution (service), and it's in charge of user interface, processing and coding of images that will then be sent to the peripheral (10), it also interprets all the data sent by the peripheral (10). For the prototype, the daemon (10) will not be executed as a service, it will be executed as a module that has to be called.

In FIG. 4 image processing (16) is shown and it's divided in four stages: filtration (1), coding (2), multiplexing (3) and structuring (4).

In the filtration stage (1), the image is captured and changed into a gray scale, then it's fractioned according to the dimensions of the electromagnet matrix (rows×columns) that are in the peripheral (10), the color in every fraction is obtained with a standard image pondering algorithm, located in image processing libraries.

In the coding stage (2) the image, once changed into a grayscale and fractioned can be seen as a numerical matrix in which every number has a value in the gray scale that is between 0 and 255. At this point, the coding (2) is done, depending on the definition value in which the system is working, for example, if working in an 8 tone definition, the peripheral (10) will be configured to represent only 8 different tones of gray, assigning each value in the gray scale an out tone equivalent in a smaller scale, while if the definition is 256, it would represent every tone in the gray scale. The value of the definition can be changed in the software.

Then, each one of the out tones (each one of the positions in the numerical matrix) is changed into a character array of zeros and ones, which will be translated as a pulse train that is sent to one of the elements in the grids (24) and (25) in the peripheral (10) in a later stage, making possible in this way to get different signals from electromagnetic fields in the electromagnets in the grid (24).

In the multiplexing stage (3), n time trains are multiplexed for each one of the parts in which the image is fractioned. For the example n=48 impulse trains, one for each one of the fractions of the coded image and these trains of pulses in time are multiplexed, making a new pulse train of 48 bits where the first bit corresponds to one of the bits in the first train, the second bit corresponds to one of the bits in the second train, and so on, depending on the instant in which it is.

In the structuring stage (4) the multiplexed pulse train is handed to the LibUSB library (14), which takes care of putting together the scheme of data that is going to be sent to the peripheral (10), where the data block is the multiplexed pulse train obtained in the last layer.

In the computer, the LibUSB library (14) is in charge of doing all the tasks related to communication through the USB port (Universal Serial Bus) (29).

For implementing the daemon (13) Python language and the Python Image Library (PLI) were used.

The LibUSB layer (14) is a library that works as a communication bridge between the USB core (15) and the daemon (13) layers. It contains the main user USB device access functions, according to USB 2.0 specifications.

The library LibUSB (14) and the Python headers were used to create a dynamic language module, the USB module, in order to make calls to the libUSB (14) API form the language, this library is usually accessed through the C language.

The USBcore (15) layer is a GNU/Linux module that allows USB (23) communication. Communication between the peripheral (10) and the computer (12) is done through the USB port (29), due to its features and popularity.

The peripheral (10) is a low speed device, meaning, it works at 1.5 Mbps and interrupt transfer was the data transference type that was used.

The peripheral (10) is made of a software part embedded in a microchip (26) and a hardware part. The software part of the microchip is divided in two layers, firmware (20) and the embedded program (21).

The firmware (20) is a layer that allows the interpretation of the USB protocol through software embedded in the microchip (26), given that the selected microchip (Motorola HC08JB8) has a USB module.

The program (21) is the highest level layer located on the side of the microchip (26). It's the final application in the microchip (26), and it's in charge of interpreting the information sent to the peripheral (10) from the computer (12) and representing it on the electromagnet grid (24) and the led grid (25).

In FIG. 1 the peripheral (10) is shown, it has three modules: microchip module (30), serial to parallel conversion and memory module (31) and the grid module (32) which is used for the electromagnet grid (24) and the led grid (25). The microchip module (30), is in charge of receiving and interpreting the data sent from the computer (12) and then send it to the serial to parallel conversion and memory module (31); this one is made of six 74LS259 integrated circuits, which are 8 bit addressable latches, each one of these sends a signal to a row in the grid and keep this signal until it gets new information; the grid module (32), is made by to parallel connected grids, one grid (25) made of leds (27) and the other one made of electromagnets (24), the led grid (25) which is used to run functionality tests with sighted people, while the electromagnet grid (24) is for visually impaired people. Each one of the elements of the electromagnet grid is a power circuit (26).

The peripheral (10) is created by a circuit made of three resistances, transistors, leds, capacitors, a switch, clocks, power sources, protoboard, microchips, circuit board, electromagnets and wires.

The glove (22) is shown on FIG. 2, it acts as a sensor so the user can perceive the signals sent through the electromagnet grid (24), it is necessary due to the fact that the human body is not susceptible to magnetic fields, the glove interacts through its magnet sensors (28) with the electromagnet grid (24) so that the signals are perceived as magnetic field pulses with different frequencies, that is how it is possible to establish the differences in color, according to the frequency of the pulses, as a result, it is possible to establish differences in shape and color by perceiving signals from the grid (24).

An outline with a hardware part (10) in the peripheral and a software part (12) in the computer is shown on FIG. 5.

### Hardware Module (10)

It is a module made of two sub-modules that divide the hardware (10) functions in the user interaction through the interaction device (36) and the control of the device (43). These two parts are physically separated and they communicate through a data cable, but depend logically from each other. The hardware module (10) communicates with the computer by using the TCP/IP protocol.

Control Module (43)

This module is divided in two stages distinguishable by a hardware card and a module; described in detail below:

Processing Unit (42)

The processing unit is managed by a programmable logic device, for example an FPGA (Field Programmable Gate Array), which makes all the data digital processing, such as receiving bit map of the image that is going to be represented and generating the necessary pulses for color representation in each one of the pixels in this map, and tasks like coordinating communication between the control module and the user interaction device and the computer.

Communication Module (41)

The communication module (41) is in charge of receiving the data in a communication network based on a data exchange standard protocol, for example TCP/IP, and a communication port with the Processing Unit Programmable Logic Device, for example a parallel port such as EPP (Enhanced Parallel Port).

Interaction Device (46)

This part of the hardware (10) with which the user interacts, provides an output interface (Signal Emission) (44) and an input interface (Position Sensor) (45).

These two areas are closely related, together they are a mobile device that constantly sends information on its location, according to what the position sensor (45) detects, for the signal emission system (44) to update its frequencies.

Signal Emission (46)

This module allows the system to perceive, through a special element located in the finger, different types of frequencies generated by the device. Each one of these frequencies represents an equivalent color from the image selected in the software, this way the user can recognize the presented signal. It also allows the system to identify shapes and figures through two frequencies that represent to opposite tones that present the limits of the represented signal. The device updates the information it represents according to what the processing unit indicates, unit that is constantly consulting the location detected by the position sensor (45).

Position Sensor (45)

This part of the user interaction device constantly detects the device's position on the XY plane and informs the processing unit (42) so this last one transmits the position of the image to be updated to the software module (10).

### Software Module (12)

The software module (12) is executed in the computer, divided in: Applications, interface, Processing and Communication with the hardware module.

Applications (44), (45), (46)

It's the software(12) area that makes possible to determine the kind of use given to the device at a given time, the use can be of two kinds: text and image recognition, nevertheless interaction with other complementary modules, to extend the functionality of the device, is possible.

Image Module (44)

It allows the system to select and image or shape from a data base or logic file in the computer, for it to be represented on the device by areas according to what the user selects, allowing movement over the image and zooming in and out.

Text Module (45)

It makes possible to select a text file and make the conversion of each one of its characters to the corresponding image in Braille code and send them to the Processing layer, in order to be represented in the device, it also has current position identification functions in the whole document, as well as movement and search.

Other Modules (46)

These are other possible modules that can be developed to extend the functionality of the device:

TTY Module: uses the Braille text module to represent text that shows on a tty or GNU/Linux standard terminal.

Video Module: it's in charge of periodically sending screen captures from a video file to the Processing layer.

Web Module: It makes possible to alternate between text and graphics in order to surf the websites with high multimedia content.

Interface Layer (47)

This layer is the part of the software (12) with which the user interacts, it has a graphic user interface that allows the system to load the modules to alternate between the different functionalities of the device. It also presents speech based complements that allow visually impaired people to work better.

Processing Layer (48)

It's a program in constant execution (service or daemon), image processing and coding (48) which will then be sent to the peripheral, it is also in charge of answering all the requests that come form the device through the communication layer (49).

This layer makes data transmission optimization processes, sending to the device only the information that has changed.

Communication Layer (49)

This layer is in charge of doing all the coding process needed for transmission and reception to the device, it implements the TCP/IP protocol which is necessary for communication with the peripheral. It also makes search procedures of the device and it allows the rest of the software layers to keep working even if connection with the device is lost.

### System Applications

Image module: it loads the image and sends it to the Daemon layer.

Screen module: it takes screenshots periodically and sends them to the Daemon layer.

Braille text module: it reads a text file and converts each one of its characters into the corresponding Braille image and sends them to the Daemon layer.

TTY module: uses the Braille text module to represent the text shown on a tty or standard GNU/Linux terminal.

Video module: it periodically sends screenshots from a video stream file to the Daemon layer.

Web module: it allows the system to switch between text and graphics to surf web sites with high multimedia contents.

Replace USB connection with a wireless connection.

Completely substituting a conventional monitor.

Connecting a PDA peripheral and a WebCam so a visually impaired person can perceive a representation of the outside world while moving around.

### INVENTION OBJECTIVES

The invention is a solid base for countless applications, such as screen, Braille text, tty and web modules.

The invention is a solution not only for visually impaired people but also for people who are also hearing impaired.

A graph coding was also created, which allows the serial transmission of graphics and can be understood by visually impaired people who can learn shapes, figures and colors.

1- A system that allows anyone with the sense of tact to perceive images, shapes, figures and colors characterized because said system has an output peripheral in a signal emitting module that uses magnets to emit magnetic fields with frequencies that have different speeds that are generated according to the shape or color of an image in a bitmap, a position sensor for the represented image and a control module that generates the differentiation of frequencies with different speeds composed by a programmable logic device embedded which can manage all the devices in the system in a parallel way to code visual information and change it into tactile through software without using Braille.

2- System according to claim 1, characterized because the output peripheral emits magnetic fields with different frequencies that are generated according to the shape or color of an image and has n elements or power circuits.

3- System according to claim 1, characterized because the signal emitting module generates the different speed frequencies using signal generating elements in the form of frequencies of magnetic fields that excites receptive elements that transfer these signals in frequencies perceptible through tact.

4- System according to claim 1, characterized because it has a processing unit in a control module ruled by a programmable logic device that receives bit maps of an image and generates pulses for each one of the pixels in this bitmap.

5- System according to claim 1, characterized by having an input interface module establishing the position of the programmable logic device through a position sensor.

6- System according to claim 1, characterized because the signal emitting module makes possible to identify shapes and figures through two frequencies that represent two opposite tones that represent the limits of the represented signal.

7- System according to claim 1, characterized because the position sensor constantly detects the position on the XY plane of the represented image.

8- System according to claim 1, characterized because the representation of the image is made by areas that makes possible to move on the image and zoom in and out.

9- System according to claim 1, characterized because it includes a data base with images designed to be coded and classified by topic.
